(19) United States
(12) Patent Application Publication
(10) Pub. No.: US 2003/0154405 A1
(43) Pub. Date: Aug. 14, 2003

(54) Information processing system and method

(76) Inventor: John Harrison, London (GB)

Correspondence Address: MCDERMOTT WILL & EMERY, 600 13TH STREET, N.W., WASHINGTON, DC, 20005-3096, US

(21) Appl. No.: 10/220,063

(22) PCT Filed: Feb. 28, 2001
(86) PCT No.: PCT/GB01/00867

(30) Foreign Application Priority Data
Feb. 28, 2000 (GB) 0004656.5
Aug. 25, 2000 (GB) 0021096.3
Dec. 21, 2000 (GB) 0031258.7

(51) Int. Cl. H04L 9/00

(52) U.S. Cl. 713/201

(57) ABSTRACT

Information processing methods, systems and ancillary apparatus are disclosed which are generally concerned with the principle of making use of verified information concerning a user whose identity has been verified and stored on a secure server. The server effectively provides a point of presence which third parties may make use of to send or receive information to or from or concerning a specific user reliably, whilst enabling the user to retain control over the information, typically by means of a key such as a smartcard. This may facilitate a variety of transactions over a network, such as the Internet, which would otherwise require separate verification processes to provide the same level of reliability and thereby lead to a surprising improvement in efficiency of the network.

The present invention relates to provision of information over a network. The invention is particularly, but not exclusively, applicable to supply of information over the Internet, for example for completing electronic transactions.

A benefit of a network such as the Internet which allows effectively open access from a multitude of access points is that it is possible for a user to communicate and to perform a variety of transactions without being tied to a particular physical location. A potential drawback, however, is that, because the user is not tied to a location, it is difficult for a party communicating with the user to be certain that the user is genuine.

Pursuant to the invention, it has been realised that there are many cases where it would be desirable for a user to be able to release information over a network selectively to third parties in a manner which allows the individual to control the release of information but also allows the third parties to be confident that the information supplied by the user is genuine. For example, when completing an on-line transaction such as an order, a user may fill in an on-line form supplying details such as name and address information. It is possible, however, for a fraudulent user to supply false information and in many applications, the recipient of the information must perform separate checks to verify that the information is correct. It would also be desirable for a party to be able to contact a user reliably with confidence that the recipient is the intended recipient. A significant amount of processing resources and network communication traffic is dedicated to verifying that a user requesting a transaction is genuine.

So-called “digital signatures” are known which enable the authenticity of, for example, an e-mail transmission to be verified. Whilst these offer a first measure of protection, use of such a signature would not prevent a user from supplying a false address or other details on an on-line application form.

Systems have also been proposed for automatically completing certain on-line forms. However, the information supplied is under the control of the user and cannot therefore necessarily be relied upon by third parties.

Certain organisations, particularly official organisations, maintain databases which contain information which has been verified and can be regarded as reliable. However, this information is, for obvious reasons, not generally made accessible and so cannot be directly used as a source of reliable information.

Thus, with existing systems, a party who wishes to verify information provided by a user must generally perform independent verification of any information supplied. This increases processing overhead, may consume network bandwidth, may increase processing times and may in any event not be wholly conclusive; often an online translation cannot be completed until a secondary verification process has been completed. Conversely, there is no ready means for a party to deliver information reliably to a user and be confident that the user is indeed the intended recipient; sending messages to an e-mail address is unsatisfactory because there can be certainty neither that the message is reliably delivered nor that the recipient is genuine.

It is a general aim of at least preferred embodiments to facilitate transactions over a network which are dependent on the true identity of a user by reducing the amount of verification that must be performed subsequent to or prior to each transaction.

In a first aspect, the invention provides a method of providing a point of presence on a network for a user whose identity has been verified, the point of presence providing a source of verified information corresponding to the user or a destination for received information directed to the user, the method comprising: verifying the identity of the user, storing on a secure server verified information corresponding to the user based on the verified identity; providing to the user one or more keys, the server being configured to permit the user, on validation of at least one key, to release verified information or to access received information but not to modify the verified information. The step of verifying the identity of the user may be carried out as a separate step or by a separate organisation.

It will be seen that this enables a trusted point of presence to be provided, which may be used either for supplying or receiving information, or more preferably both. Because the information is stored on a secure server and based on the verified identity, and because the information is provided from the secure server, not directly from the user, any recipient of the information can consider the information to be as reliable as the identity verification process which leads to the original storage of the information. The provision of a key to the user enables the user to control selective release of the information or access to documents without having to repeat the original identity verification process. Because verification of subsequent transactions can be avoided or at least reduced, network bandwidth can be saved and processing of transactions can be made more efficient. A surprising potential benefit is that, in addition to benefits for servers which make use of the verified information, provision of such a point of presence for a number of users may, by reducing network transactions, enable unrelated portions of a network to function more efficiently, leading to a clear technical benefit even for network users who are not directly associated with the point of presence or for servers which rely on conventional verification processes. Thus, a potential remarkable benefit is that addition of a service according to the invention to a congested network may actually alleviate congestion on the network. In some cases the provision of a key may comprise registering details of a “key” already possessed by the user rather than physically providing the user with a new key. For example, biometric information (e.g. fingerprint, retinal scan, voice print etc) may be recorded and subsequently used as a primary key (in addition to or instead of as a secondary key, for example to unlock a smartcard, as discussed below). This may be highly secure and has the benefit that the user need not carry an additional physical key or remember a password key; a potential drawback is that the key reader for such a key may need to be more complex or expensive than a key reader for a key such as a smartcard or password and so the user will normally (but not necessarily) be provided with an additional key even if such a primary key is used.

In this specification, references to verifying the identity of a user are intended to connote a process which involves checking the purported identity of a user with that indicated on a document or record (which term is not limited to text documents or documents in tangible form) issued by an independent organisation, preferably an official organisation, preferably after a verification process. References to verified information are intended to connote information which has been supplied by or cross-checked with a source of that information substantially independent from the user. For example, in the case of an individual user, verifying identity may include requesting presentation of an official document such as passport or driving licence and may also comprise asking questions to which a person other than the genuine individual is unlikely to know the answer. Verified information may include name and date of birth and address, some of which may be verified by means of the official document and some of which may be verified with reference to other sources, for example address may be verified with reference to one or more utilities bills or official records. The stringency of the verification process may be selected according to the purposes for which the information is to be used and an indication of the level of verification may be communicated to recipients of the data. Verification preferably includes reference to two or more independent sources of information. Although the user will often be an individual, this need not necessarily be so; for example the user may be an organisation or corporate entity. For a corporate entity, a key may be issued to an authorised officer on identification, the information being stored corresponding to official records for the corporate identity. In the case of an individual, a biological characteristic of the individual may be stored and for an organisation, biological characteristics of one or more authorised officers may be stored for use as secondary security features, as mentioned further below. Verification of identity is preferably performed in accordance with a prescribed procedure or one of a prescribed plurality of procedures. Preferably details of one or more prescribed procedures are communicated or otherwise made available on request to at least one recipient or source (intended or actual) of information or the identity of the secure server is verified to the recipient or source (for example the host of the secure server may have a digital signature) Preferably the secure server is configured to transmit information certifying that a user's identity and (or) the verified information has been verified in accordance with a prescribed procedure. The certifying information may be specific to a particular item of information, or may be generic for a secure server, certifying that all users or all information has been verified in accordance with a prescribed procedure. This enables the source or recipient to be confident that an appropriate identity checking procedure has been implemented.

As used herein, the term “secure server” is intended to include any device capable of connection to a network for storing information in a manner that is not generally accessible over the network and releasing that information over the network following validation of a key. In preferred implementations, the secure server may comprise an Internet host, and will usually be configured to establish secure Internet connections with recipients of information and with a user access point. The server need not necessarily be a discrete entity but may itself be comprised of distributed elements connected by means of the same or a different network. It is important to note that, although the user may control the use of the data stored on the server, the accuracy of the data stored on the server is under the control of the host. Whilst the user may request a change in the information stored, the host controls the conditions under which the information may be changed and has responsibility for the delivery of such information to the recipient.

In a preferred implementation, the network is a publicly accessible distributed network, such as the Internet. Preferably the secure server is arranged to receive the or each key over a secure connection over the network.

The method of the first aspect may further comprise receiving a request from a user to provide at least a portion of the verified information to a specified recipient over the network and providing information to the specified recipient over the network following verification of at least one key provided by the user.

According to a related second aspect of the invention, there is provided a method of supplying verified information concerning a user over a network to a recipient, the method comprising:

storing on a secure server verified information corresponding to the user whose identity has been verified and based on the verified identity;

receiving at the secure server a request from the user to provide at least a portion of the information to a recipient over the network;

verifying at least one key provided by the user to validate the request;

in response to successful validation providing verified information to the recipient from the secure server over the network.

Thus it can be seen that the second aspect makes use of information stored in accordance with the first aspect.

In a preferred application, the key comprises information stored on a key carrier and validation of the key preferably comprises reading information directly from the key carrier (a physical entity). This is particularly secure as only a user having physical possession of the key carrier is able to release the information.

Although the key carrier may comprise a passive device (including but not limited to a card or the like carrying a magnetic stripe, having a bar code, or having a configuration encoding information), the key carrier is preferably (for greater security) a smartcard. The term “smartcard” as used herein is not limited to conventional smartcards but includes any device which includes embedded logic which controls access to information stored therein, regardless of physical form (which may include conventional cards or keyshaped objects). Preferably the smartcard is a multi-application smartcard including means for storing a key, such as a PKI digital signature or some other (more or less secure) equivalent, affording access to the verified identity, typically by means of a first application, and means for storing at least one other application which may make use of the user's verified identity, for example a credit-card, debit card or loyalty card application, or driving licence details. The key carrier will normally store at least an identifier of the user (for example a unique identifier or at least the user's name).

Preferably, access to the key carrier is further protected by means of a secondary security feature, for example a PIN number or password or other security code or combination, so that successful validation requires both physical possession of the key carrier and possession or knowledge of the secondary security feature. Where the key carrier is a smartcard, the logic embedded in the smartcard may be arranged to require the secondary security feature to gain access to the key. The nature of the secondary security feature may depend on the level of security required. In a preferred, highly secure, application, the process of verifying the user's identity may include measuring a (distinctive) biological characteristic of an individual user (for example a fingerprint, retinal scan, (at least partial) DNA profile etc.) and storing this information, preferably on the key carrier, as the secondary security feature. The process of accessing the key carrier may include verification of the biological characteristic; this ensures that only the true owner of the key can access it.

In some applications, however, it may be desirable for the user to be able to release the information without requiring a physical key carrier. In such a case, the key may comprise a password and ID combination which enables a user to log in to the server, or may comprise a digital signature or the like which is transmitted electronically, for example over a network or on a data carrier to the user, for example to be stored on a user's personal computer. Such systems may facilitate access to the data, but at the cost of reducing overall security.

In addition to the verified information, further information may be stored which is (more readily) modifiable by the user (on presentation of a key). Looked at another way, the information stored may comprise a plurality of categories of information, the authorisation required to read or modify the information varying between the categories. Some information may be categorised as being readable or writable by specific authorised users or classes of users (for example medical records by a medical practitioner) and some (for example the user name) may be categorised as readable by all.

In certain cases, therefore, information may be transmitted to recipients without authorisation of an individual request by a user; for example a user may consent to his or her medical records being supplied to an authorised medical practitioner on request. In such a case, a third aspect of the invention may provide a method of supplying verified information concerning a user over a network to an authorised recipient, the method comprising:

storing on a secure server verified information corresponding to the user whose identity has been verified and based on the verified identity;

receiving at the secure server a request from the recipient to provide at least a portion of the information over the network;

verifying at least one key provided by the recipient to validate the request;

in response to successful validation providing information to the recipient from the secure server over the network.

The user may specify that certain recipients may access data without authorisation each time, most conveniently by requesting issue of a key with specified permissions to the recipient.

The invention may also provide, in a fourth aspect, a method of transmitting data concerning a user to a recipient, the method comprising transmitting the data concerning the user to the recipient over a network from a secure server and further comprising transmitting an identifier indicating that at least a portion of the data transmitted comprises verified information stored on the secure server following verification of the identity of the user.

The invention further provides, in a fifth aspect, a data packet comprising information concerning a user and an identifier indicating that the information has been stored on and transmitted from a secure server following verification of the identity of the user and verification of at least a portion of the information, the identifier preferably identifying which portion(s) of the information comprise verified information. The identifier is preferably a key and the data is preferably transmitted over a secure connection.

A recipient of the information may then be confident that the information can be trusted.

A host making use of the information may do so according to a sixth aspect of the invention which provides a method of obtaining over a network verified information concerning a user whose identity has been verified, comprising:

requesting information from a user;

establishing communication over a network with a secure server on which is stored verified information concerning the user based on a verified identity of the user;

following provision of at least one key by the user and validation by the secure server of the or each key supplied, receiving verified information from the secure server over the network, the verified information preferably including an identifier indicating which portion(s) of the information has been verified.

Pursuant to the invention, it has been appreciated that provision of a secure and independently verified identity may facilitate or enable variety of transactions to be performed electronically which were not conventionally possible. Effectively, the server storing a verified identity provides a point of presence on a network which can provide functions analogous to a user's postal address. In a seventh aspect, the invention provides a method of providing a point of presence for a user on a network comprising verifying the identity of the user and providing on a secure server verified information identifying the user based on the verified identity, the server being configured to receive communications directed to the user.

Referring back to the first aspect, the method preferably further comprises receiving a communication directed to the user and processing the communication in accordance with at least one predetermined condition. The server may be configured to permit the user to modify some or all predetermined conditions directly, preferably following validation of at least one key, or to request modification, which request is verified before modification is actioned.

The communication may comprise, for example, a debit or credit transaction request, a document to be notified to the user (this may facilitate electronic service of documents), or a request from a source to deliver a physical item to the user.

In the absence of electronic banking, a user who receives a cheque may choose to pay that cheque into any one of his or her accounts and similarly a user who receives an invoice may choose to pay that with funds from any of his or her accounts. Such arrangements therefore offer a user some flexibility, but require the user physically to receive a cheque or payment request. Electronic payment systems, which greatly facilitate the transfer of funds, such as the Bankers Automated Clearing Services (BACS) have been used for some time. One disadvantage with such systems, however, is that a user must specify a particular account into which credits are to be made or from which debits are to be taken. The eighth aspect of the invention may enable the flexibility of non-electronic systems to be regained while maintaining the convenience of electronic funds transfer systems, by providing a method of processing a debit or credit transaction request comprising, at a secure server on which is stored a database of information corresponding to a plurality of users the identity of whom has been verified, the steps of:

receiving the transaction request, the request including an identifier of a target user with whom a transaction is requested and an identifier of the requester;

searching the database for information identifying at least one banking server capable of processing the transaction request for the target user and, if successful,

forwarding the transaction request from the secure server to a banking server with authorisation to complete the requested transaction in accordance with at least one predetermined condition, or returning an identifier of a banking server and account to the requester.

In this way, a request for payment or a credit can be addressed to a user via the secure server rather than directly to a bank account and a user may specify a default bank account through which payments are to be made. Provision of such a method allows a user to have an effective point of presence which is not tied to a particular bank account. The mechanism by which it is provided provides an advantage in enabling a payment request to be directed automatically over a network to a banking server, without the requester requiring knowledge of the bank account from which funds are to be provided and without consuming excessive network or processing overhead.

The predetermined conditions may include a condition to hold a request at the secure server pending authorisation by the user. The conditions may specify that the request should be forwarded to a default banking server if not processed within a predetermined length of time. Conditions may apply to every request, or to requests of a certain category or from certain requesters or from certain categories of requesters. Not all users in the database may store banking information and the method preferably comprises acknowledging the request or signalling if the user is not identified or banking information is not provided for the user. The transaction may be completed directly between the banking server and requester, but the fact of completion may be signalled back to the secure server. As an alternative to forwarding the transaction to the banking server, the secure server may return an identifier of a banking server (and account) to the requester. The secure server may itself serve as a banking server and may complete the transaction directly, optionally further completing a transaction with a separate banking server.

In addition to or instead of serving as a point of delivery for transactions such as financial transactions, the point of presence may serve as a delivery point for other important documents or transactions where it is necessary to ensure that a document has been correctly delivered to a desired person. For example, service of legal documents require positive acknowledgment and other important items are often sent via recorded delivery to a person's postal address. If a reliable means could be provided for ensuring that a document is correctly delivered, certain persons. (natural or legal) could opt to accept service of documents electronically. This may be provided in a ninth aspect in which the invention provides a method of receiving a document destined for a user for which acknowledgment of receipt is required, the method comprising, at a secure server on which is stored a database of information corresponding to a plurality of users the identity of whom has been verified, the steps of:

receiving from a source a document and an identifier of a target user;

searching for notification information for the target user in the database, and, if successful, notifying the user of receipt of the document based on information stored in the database;

following successful notification, signalling to the source that the document has been notified to the target user.

Notification may comprise sending a message to a communication device (for example a pager or mobile telephone associated with the user) or may comprise notifying the user the next time the user accesses the secure server (by means of at least one key, which ensures that the document is reliably notified). Notification may be a two part process, a first part signalling, for example by sending a short message, indicating the fact of arrival of a document, and in certain cases a summary or title or some abbreviated identifier of the document, and a second part comprising giving the user access to the document, for example when the user logs into the secure server. Notification may occur automatically when a user next logs in. In certain implementations, the user may be permitted to specify that the document should be delivered to another location, for example a conventional E-mail address following acknowledgement of receipt. Signalling may occur as soon as the document is notified., or may require a user to acknowledge receipt of notification, and may signal time and/or date and/or place or means of notification.

Although searching for notification information and notifying the user will in most cases require a positive step of notification, the user may indicate that any communication received at the secure server is deemed notified, in which case searching will return information to that effect and the notifying step will not be performed positively.

A further advantage of providing a point of presence is the ability to co-ordinate delivery of physical objects, for example parcels. Physical delivery of parcels to a postal address is often problematic as the intended recipient may not be available and it may not be possible to post the parcel through a letterbox. Particularly in the case of a recipient who travels between a variety of locations, it may be extremely troublesome for both the delivery agent and the recipient to coordinate delivery of a parcel. In a further aspect, this problem is alleviated by enabling a delivery request to be sent electronically to a point of presence corresponding to the verified identity of the recipient (which minimises the risk of unauthorised interception of the parcel) at which is stored delivery preference information. In a tenth aspect, the invention provides a method of controlling delivery of a physical item to a user, the method comprising, at a secure server storing a database of information corresponding to a plurality of users the identity of whom has been verified, the steps of:

receiving over a network a request from a source to deliver a physical item to a target user;

searching for delivery preference information for the target user in the database and, if successful,

communicating to the source delivery preference information for the target user.

In certain cases, the recipient may opt to be notified when a parcel is to be sent, but normally the recipient will store preference information to be used by default. The recipient may be notified that a parcel will be delivered in accordance with delivery preference information. The delivery preference information may include, for example, one or more physical delivery addresses, with associated delivery times or instructions to store items for collection or later delivery (for example if the user is absent).

The invention also extends to apparatus for performing any of the above methods (including, but not limited to servers, network terminals or communication devices, key-carriers or smartcards configured for use in any of the above methods) as well as computer program products or data packets containing computer readable instructions for performing any of the above methods. The invention further provides use of verified information, based on a verified identity of a user and stored on secure server, in a transaction over a network requiring verified information. Further aspects are set out in the independent claims and preferred features are set out in the dependent claims to which reference should be made

In a related apparatus aspect, the invention provides a key carrier issued to a user following verification of the user's identity and carrying a key affording access to verified information stored on a secure server concerning the user, for use in the method of any preceding aspect. The key carrier is preferably a smartcard, preferably a multi-application smartcard containing an application (for example a credit or debit card application) in addition to the key.

In a further apparatus aspect, the invention provides a multi-application smartcard comprising means for storing a plurality of applications on the smartcard and means for communicating common information between the, applications, preferably information concerning the identity of a user based on information which has been verified and stored on a secure server. In this way, a smartcard may serve as, for example, credit or debit cards, individual credit or debit card applications being added and making use of secure information stored on the server which has been independently verified.

In an eleventh method aspect, the invention provides a method of managing applications on a multi-application smartcard comprising displaying a list of applications on the smartcard and in response to a request from a user, which request is preferably validated by key or secondary security feature, modifying the applications stored on the smartcard. Preferably a mirror of the smartcard is stored on a secure server (preferably together with verified information stored in accordance with the first aspect) and modifying or displaying the list of applications includes accessing the secure server. Modifying may include downloading a further application or deleting an application. For example, a user may choose to add an additional credit application provided by a new provider to the multi-application-smartcard. The additional application may be downloaded over a network. The method may include submitting verified information concerning the user to a provider of a further application.

The key of any of the preceding aspects may be stored in a communications device, such as a mobile communications device (for example a telephone or other communications device) which is configured for connection to the network. Such devices generally include a Subscriber Identity Module (SIM) card and the key may be stored in the SIM card which is a form of smartcard. In a further aspect, the invention provides a mobile communications device comprising means for connecting to a secure server over a network; means for storing a key for accessing verified information concerning a user stored on the secure server; and means for sending a command to the secure server to release at least a portion of the verified information over the network.

There may be circumstances where a user wishes to receive certain information, for example concerning a product, but does not wish his or-her details to be permanently recorded, for example on a mailing list.

In a twelfth method aspect, the invention provides a method of directing information or an object from at least one source to a user, the method comprising:

providing information identifying an object or information of interest to the user at least one source;

providing a severable communication pathway from the at least one source to the user;

after a period of time, severing the communication pathway.

The method may include setting the period of time based on user input. At least a portion of the information may be input by the user and the method may include receiving information from the user. Providing the communication pathway may include providing an address alias. The method may further comprise providing information to a delivery agent enabling the address alias to be translated or translating an address alias on request from a delivery agent. Alternatively, the method may further comprise receiving information or an object from at least source directed to the user and forwarding the information or object to the user.

Severing the communication pathway may comprise changing the address pointed to by the alias to a dummy address, or signalling that the address is invalid or that information or objects should be returned to the at least one source.

The method may include communicating information identifying characteristics or preferences of the user, but not uniquely identifying the user, to the at least one source, for example wide-area postcode, preferences, gender, approximate age, income band, optionally at the option of the user. The method may be integrated with any of the methods according to any preceding aspects and make use of information stored on a secure server.

In a thirteenth method aspect, related to the eighth method aspect, the invention may provide a method of processing a financial transaction via a computer network having verified information concerning at least one of a donor and recipient of funds stored on a secure server, the method comprising:

forwarding a request for funds to a banking server associated with the donor configured to output a data packet comprising an electronic bankers' draft;

forwarding the data packet to the recipient;

forwarding the data packet from the recipient to a banking server associated with the recipient;

transferring funds between the banking server associated with the donor and the banking server associated with the recipient to complete the transaction.

By forwarding an electronic bankers' draft, the recipient can know on receipt that funds will be credited, without needing to obtain authorisation directly from the bank, thereby reducing the amount of network traffic and communication time before the recipient is satisfied of funds receipt. Also, because the funds need not be directly transferred at the time of receipt, multiple payments can be consolidated, allowing reduction in the number of transactions over the banking network; preferably funds corresponding to a plurality of transactions are consolidated prior to transferring funds between the banking servers.

In one embodiment, verified information concerning the recipient is stored on the secure server and the data packet is forwarded to the secure server. In another embodiment, verified information concerning the donor is stored on the secure server and the request for funds is forwarded from the secure server. Where information concerning both donor and recipient is stored, this may be stored on the same or different secure servers. Similarly the banking servers associated with the donor and recipient may be the same or different.

A potential advantage of linking the payment processing system with a source of information is that a credit or payment history can be created or updated dynamically based on payments made by a user or bills received, for example based on the time taken to pay a bill. The method may further include modifying a credit record based on a received request for payment or a payment instruction. This may be provided independently in a further aspect in a method of processing data comprising at least partially processing a payment transaction or request at a secure server at which verified information concerning a user is stored (preferably in accordance with one or more other aspects), at least part of which verified information is under the control of the user, and modifying a credit history record associated with the user based on the payment transaction or request.

The invention also provides a data packet transmitted over a network comprising an electronic bankers' draft originating from a banking server and containing information to credit an amount of funds pre-allocated by the banking server, the packet being authenticated by the banking server.

Further preferred features will become apparent from the following description of a preferred embodiment, which is provided by way of example only. In the following, individual features disclosed are not limited to the context in which they are described but may be provided individually or in combination with other features, unless otherwise stated. Reference should be made to the accompanying drawings in which:

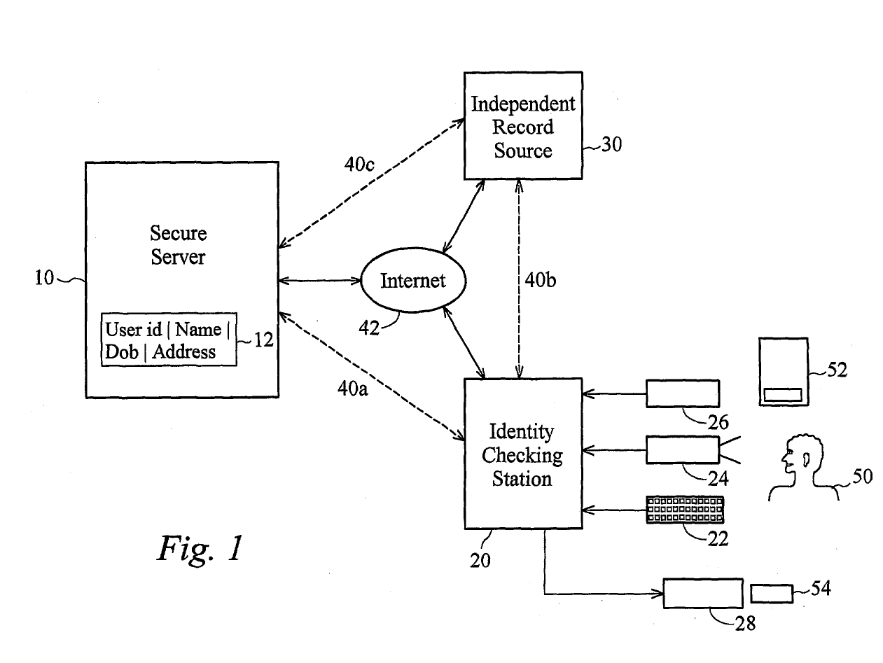

FIG. 1 is a schematic overview depicting the process of registering an identity on a secure server in accordance with an embodiment of the invention;

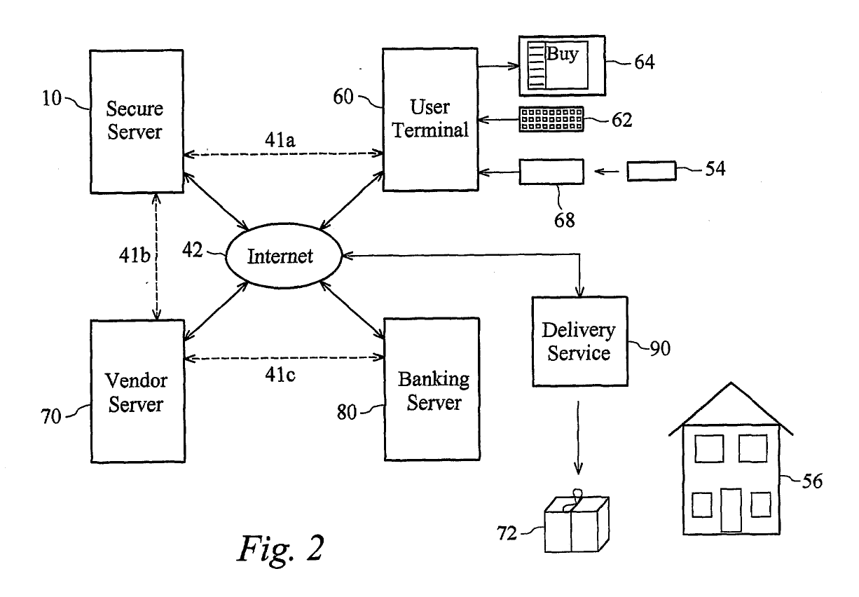

FIG. 2 is a schematic overview of a process of completing an online purchase in accordance with an embodiment of the invention;

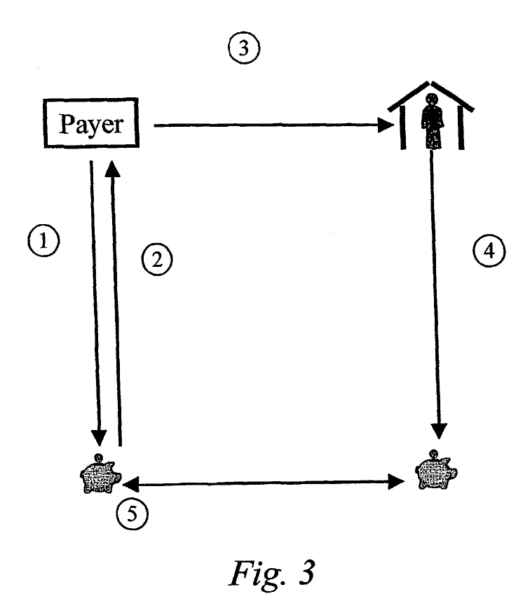

FIG. 3 is a schematic overview of a financial transaction employing an embodiment; and

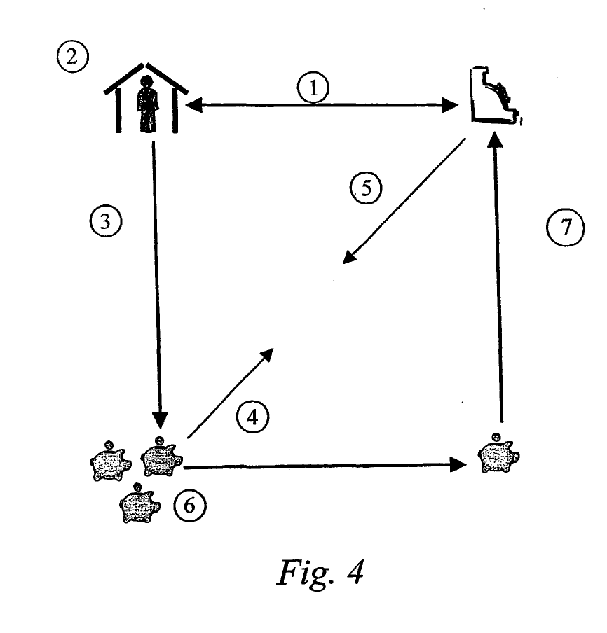

FIG. 4 is a schematic overview of a further financial transaction employing an embodiment.

Referring to FIG. 1, a process for creating on a secure server 10 a record 12 of verified information for a user 50 whose identity has been verified will now be described. At an identity checking station 20, a user 50 presents one or more documents 52 from official sources, for example a passport or driving licence.

The identity checking station may have a keyboard 22 or other input device for inputting information concerning the user or inputting the details manually read from the document(s) 52.

The identity checking station may also have camera means 24 for recording an image of the user. In certain embodiments, the camera means 24 may be coupled to image processing apparatus arranged to compare an image of the user with a stored reference image, for example from a passport record. This may facilitate automation of the identity checking station, but usually it will be desirable to have an operator overseeing the checking process.

The camera may be supplemented by biometric reader apparatus, for example fingerprint recognition apparatus for reading a fingerprint, retinal scanner apparatus for obtaining a retinal image or DNA analysis apparatus for analysing a characteristic of at least a portion of DNA from the user. The biometric reader may be arranged either for comparing that sample or image to a stored reference sample to verify the identity of the user or to store the image for future validation of the user.

In addition, a document reader 26, for example comprising a bar code scanner for reading a passport or driving licence bar code or a magnetic strip reader or smartcard reader for reading information contained on a credit card or other suitable identification card or a text or image scanner for obtaining an image of a document may be provided. It will apparent to those skilled in the art that a variety of combinations of the devices mentioned or other alternatives may be provided at an identity checking station. For example, in a basic embodiment, a user may simply be required, to produce an official document such as a passport to an operator, the operator manually checking the photograph of the user and keying in the user name from the passport.

Once the identity has been checked, the identity checking station 20 communicates with the secure server 10 over communication link 40a, which may either comprise a dedicated communication link (for example over a telephone line) or, more preferably, may comprise a secure link over a computer network such as the Internet 42, to instruct creation of a verified information record 12 for the user whose identity has been verified.

Although the user may provide sufficient documents 52 to enable all information to be verified from the documents provided, it is preferable that the identity checking process includes reference to an independent record source 30. This reduces the risk of a user presenting forged documents at the identity checking station. The identity checking station may communicate directly with the independent record source over communication link 40b or the secure server may communicate with the independent record source over communication link 40c or both. Again, each communication link may be a dedicated link or may be formed as a link, preferably a secure link, over the Internet 42. The independent record source may be provided, for example, by any, one or more of a credit reference agency, a bank, or an official organisation, such as a government passport or driving licence records agency.

It should be noted that the identity checking station 20 may be integrated with the secure server 10. Similarly, either or both identity checking station 20 and the secure server 10 may include an independent record source 30; this may facilitate rapid verification of information provided.

Following successful verification and creation of a verified identity, the user 50 is provided with a key to enable subsequent access to the verified identity. This may conveniently be achieved by provision of a smartcard writer 28 which provides a smartcard 54 containing a key to the identity. At the time of creation of the smartcard, the user may be requested to provide a secondary security feature, or may be provided with one, for example a password or PIN number to enable access to the key contained on the smartcard 54. As an alternative to providing the user directly with the smartcard, as a further safeguard against users providing false addresses, the smartcard may be subsequently mailed to the user at the verified address. Where a biometric measurement has been performed, the biometric information may be stored either on the secure server 10 or on the smartcard 54 or both for use as a secondary security feature.

In certain embodiments, the user may be provided with an ID and password combination which enables access to the information on the secure server without-the use of the smartcard 54. This has lower security than access requiring the smartcard 54 but may facilitate access at a greater variety of terminals.

It can be seen that the process of verifying identity is linked to the process of storing a record of verified information and supplying a key to the user.

It will be appreciated that the use of a smartcard is but one means of storing the key and the form of the smartcard is not germane to the invention. In a preferred application, however, the smartcard 54 is a multi-application smartcard which may also store one or more applications for example credit card or payment card applications.

The verified identity for the user may comprise information selected from among the following:

a unique identifer for the user;

the user name;

the date of birth of the user;

the home address of the user;

national insurance or security or tax reference numbers for the user;

driving licence details for the user;

occupation details;

gender;

physical characteristics (for example eye colour, hair colour, height, approximate weight);

medical records;

ophthalmic records;

biometric (for example retinal scan, finger print or DNA profile)

In preferred embodiments, the user may opt whether or not to store certain of this information and may also control the extent to which such information may be released. For example, a user who intends to investigate a variety of financial services and is likely therefore to be requested to provide occupation and salary details may wish to have this information verified and stored as verified at one point so that this verified information can be supplied to various providers who accept verified information. This will greatly reduce subsequent verification which the user has to undergo. The secure server is preferably configured only to release such information on specific authorisation of the user. Nevertheless, certain users may not wish to store such information, even though it will only be released under their control, and may opt not to do so. For example, a user who wishes to make use of the service provided by the secure server only for the purpose of having mail directed to an appropriate address (as will be described below) may only register a name and address.

Provision may be made for users who have registered certain information as verified to add further verified information at a later stage. In a preferred arrangement, the server may enable storage of a variety of information and may include flags indicating whether the information is present at all and whether (and optionally the extent to which) the information has been verified. Thus, for example, a user may choose not to submit verified occupation information and may subsequently be permitted to store this information on the secure server, the server indicating that the information is present but has not been verified. This may greatly facilitate completion of forms and online transactions with the recipient of the information remaining confident of the level of verification of each piece of information received.

Where different categories of information have been verified to different levels of security, an identifier may indicate the nature of the verification process. For example, categories may include

(0) information not present or default information

(1) information provided by the user but not verified;

(2) information provided by an authorised information provider (for example a credit reference agency);

(3) information provided by user ((a) as part of initial verification process or (b) subsequently) and verified with reference to documents produced by the user;

(4) as (3) but information further cross-checked with reference to external records.

The access permitted to information may also vary between the categories information, as will be explained.

A first write access category may comprise information which may only be written by the host as part of the initial verification process. Such information may include, for example, the name and date of birth of a user and a unique identifier of the information.

A second write access category may comprise information which may be written and subsequently altered by the host, preferably in accordance with a predetermined verification process. Such information may include, for example, the address, marital status, credit information and certain other information concerning the user. In a preferred implementation, the user, whilst not being permitted to write the information directly, may request a change of such information, the change being implemented by the host after verification of the new information.

Both of the above would normally be certified as verified in category 3 or 4 above.

A third write access category may comprise information which is writable or modifiable by the user, on validation of the key, without independent verification by the host. For example, the information may include preferred contact details, preferences for a variety of options such as display of information, information to be selected or rejected as of interest to the user etc. Where more than one key is provided, modification of the information may require validation of a more secure key, for example use of a key carrier, or may require an additional key or password, compared to the level of validation required to release the information (which in certain cases may be authorised by use of a password).

Such information would normally be certified as not verified (category 1 above).

In the above categories, the information will normally be readable by the user and the host, and may be supplied to third parties under the control of the user. The information may also be made readable by authorised third parties without specific authorisation and some information may be made generally readable by third parties. For example, the user may wish to have contact details such as a telephone number or e-mail address placed in a directory or may be prepared to receive promotional information for certain categories of products. This may comprise information in any of the verification categories.

A fourth write access category may comprise information which may be written or altered by certain specified parties, preferably following validation of a key possessed by the third party. Such information may comprise, for example, medical or ophthalmic records or driving licence details, or credit records. This would normally be certified as verified in category 2 above. A user may opt to authorise all doctors to access medical records or only a specified doctor; this may be implemented by issuing all doctors with one or more keys which give (1) generic identification as a doctor and (2) specific identification. The records may be set so that any doctor may read the information but only a specific doctor may modify the information. Similar principles apply to other categories of information. For example financial information may be made readable by all authorised financial organisations, but only writable by specific credit reference agencies.

The following table exemplifies the permissions which may be given to different parties. In the following, W signifies write permission, WO signifies permission to write once, R signifies read permission, M signifies modify permission and an asterisk indicates that the permission may be changed at the option of the user. CRA denotes a credit reference agency and DVLA denotes a driver licensing organisation. Where the user has read permission, he or she may opt to have the information transmitted to a designated recipient. Some information may not be readable by the user, for example the medical record or portions thereof.

| Informa- | | | | | | |
|---|---|---|---|---|---|---|
| tion | Host | User | Doctor | DVLA | CRA | Public |
| Name, id | WO, R | R | R | R | R | R* |
| Address | W, M, | R | R | R | R | R* |
| | R | | | | | |
| Credit | W, M, | R | — | — | W, M, R | — |
| Rating | R | | | | | |
| Medical | — | R | W, M, | — | — | — |
| record | | | R | | | |
| Driver | W, M, | R | — | W, M, | — | — |
| details | R | | | R | | |
| Contact | W, M, | W, M, | R | R | R | R* |
| details | R | R | | | | |
| Pref- | W, M, | W, M, | — | — | — | — |
| erences | R | R | | | | |

It will be appreciated that the access and verification categories are linked and may change; for example a user may initially supply information (which is placed in verification category (1)), then subsequently have that information verified (promoting it to category (3) or (4)). The access rights may then be changed by the host, preventing further modification by the user, or alternatively subsequent modification may demote the information back to verification category (1). Whereas for certain information it may be desirable for the user to determine the access category, certain basic information (such as name) may be restricted to the first or second access category.

Referring now to FIG. 2, a transaction making multiple use of preferred features of embodiments will now be described. As will be apparent, each of these features may be provided independently.

A user accesses a user terminal 60 which may include an input device such as a keyboard 62 and typically a pointing device such as a mouse (not shown) and an output such as a display screen 64. The user terminal also has a smartcard reader 68 for reading a user smartcard 54 containing a key. Such a terminal may be provided as an Internet kiosk with a smartcard reader and may be generally publicly accessible. As an alternative, the user terminal may comprise a personal computer or digital interactive television or the like owned by the user. In such a case, a key to the information stored on the secure server may be stored (preferably securely) in the terminal itself. As a further alternative, the user terminal may comprise a mobile device, such as a telephone or communicator and the key may be stored in a SIM card or may comprise a password or number entered into the communication device. In place of a keyboard 62, voice or handwriting recognition devices or other input means may be provided and, similarly, although the output of the terminal preferably comprises a visible display, an audible or other output device may be provided. At its most basic, the user terminal may comprise any device capable of connecting to the network, communicating with a user, and transmitting some form of key to the secure server over the network.

To explain how the invention may be used in a variety of ways, there will now be described a transaction in which a user wishes to purchase a replacement mobile telephone and telephony service over the Internet and which requires (1) selecting the phone (2) satisfying the supplier that the user is creditworthy (3) execution of a contract by the user (4) transferring an initial payment to the supplier and (5) arranging delivery of the phone. Conventionally, this would require multiple steps but, as will be seen, an embodiment of the invention can greatly simplify the process.

A user in communication with a vendor server 70 over the Internet 42 (or other network), preferably via a secure link (not directly shown) may select an item to purchase, in this example a new mobile telephone with a new connection and network. The vendor may require verification of the user identity before dispatching the new device and arranging the network connection with payment in arrears. Accordingly, the vendor server sends a request to the user for verified information. In response to this, the user provides the key-carrying smartcard 54 into the smartcard reader 68 which triggers (automatically or following further manual actuation) the user terminal to communicate with secure server 10 over secure communication link 41a, which is provided typically over the Internet 42. This enables the key to be validated. Following validation of the key, the secure server 10 transmits verified information specified by the user (for example including name, address and a creditworthiness certification provided by an external credit agency but stored on the secure server) to the vendor server via secure communication link 41b, again preferably provided over the Internet 42. As an alternative to accessing the vendor and then contacting the secure server, the user may access the vendor via the secure server, for example by means of a list of approved suppliers on a shopping page or in a shopping directory; this may enable information to be send directly from the secure server to the virtual home, simplifying the process. As an alternative to storing certain information, such as a credit record or driver details, directly on the secure server 10, the server may store a pointer to information stored elsewhere, for example a record on another database. Although the data may be conveniently stored as records having a predetermined format, the information may be stored as text, which may include tags identifying each item of information, for example using a mark-up language, and the information may contain hyper links.

Once satisfied that the user is genuine and creditworthy, the vendor server may request execution of a contract. This may be electronically transmitted to the user via the secure server, the secure server providing the vendor server with a notification of receipt, and may be digitally signed and returned together with authentication information from the secure server.

Thereafter an initial payment is requested from the user. Whilst payment may be effected conventionally by supplying credit card details, necessitating separate communication with a credit card server, in this example, the vendor server sends a payment request directly to the user at the secure server. This payment request is then directed to banking server 80 in accordance with the user's specified payment preferences, as described in more detail below. Subsequent direct debits may be directed to the user at the secure server, rather than the user providing specific bank account details and the user may direct these to a chosen account.

In this embodiment, the secure server may store various preference information for the user including contact detail information. The user may authorise the vendor server automatically to update a contact number for the user with the new mobile telephone number. Alternatively, the user may already have a mobile service and number and the secure server may be employed to terminate the existing contract, by automatically filling forms using information stored (the provision of automatic form-filling based on stored information is an important feature which may be provided independently of other features). The old phone number may be transferred to the new phone, for example by storing on the server and communicating to the new supplier, or in certain cases by downloading information directly to a SIM card to be used in the new phone. Although in the example given, the telephone and connection are supplied by a single vendor, it will be appreciated that, having selected a phone, the user may separately contact different telecommunications network providers, and by providing immediate verified credit and status information stored on the secure server, may select the best offer of tariff for the new telephone, based on the user's credit rating. The server may also store, at the user's request, previous call usage information, either supplied and verified by-the user's existing supplier, or estimates supplied by the user, and this may be passed on to suppliers to assist suppliers in bidding automatically for a supply contract or to assist the user in selecting an offer.

To arrange physical delivery of the telephone, the vendor server makes use of a further feature of the embodiment, as described below under postal delivery; the vendor merely sends a request to the secure server to deliver a parcel to the user. The secure server then provides delivery preference information to delivery service 90, again over the Internet, so that the parcel 72 containing the new telephone is delivered correctly to the user's house at a time when the user expects to be present or, alternatively to the user's place of business if that is the specified preference.

### Financial Payment System Point of Presence

In a preferred arrangement, the user information may include details of one or more bank accounts from which payments may be made or into which credits may be paid in response to a payment or credit request received at the secure server 10. The user may specify a variety of conditions to direct such requests. An example of a set of conditions is shown below in table 1.

| Condition | Action |
|---|---|
| All credits over, 1000 | First pay any outstanding credit account debts, |
| | then direct to savings a/c no xx-xx-xx xxxxxxxx |
| All other credits | Direct to current a/c no yy-yy-yy yyyyyyyy |
| Specified utilities | Await authorisation; direct to A household@ a/c |
| debits | no zz-zz-zz zzzzzzzz by default if no action |
| | within 14 days |
| Mortgage debit | Check amount with calculated threshold, then |
| | direct to “household” a/c automatically |
| Debits over, 1000 | Await authorisation, then pay from savings a/c |
| | unless otherwise specified |
| Other debits | Await authorisation, then pay from current a/c |
| | unless otherwise specified |

The above method for processing debits works well for payment in arrears, where the user is known to the merchant and accepted as creditworthy. In other circumstances, where the user is not known to the merchant and there is no contract for service delivery, the merchant will require confirmation of the user's ability to pay in advance of service delivery. Conventionally such confirmation is given by using either a debit or credit card provided by the user to check the value of stored cash or offered credit in a particular current or credit account. In a preferred embodiment of this invention, the secure server will maintain a record, which is frequently updated, of the total of stored cash and offered credit which is available to the user across a range of accounts, possibly held with more than one financial institution. It will thus be possible to respond to a merchant request's for payment authorisation based on the total payment capacity of the user, and without direct reference to balances of individual accounts held on one or more banking servers.

Referring to FIGS. 3 and 4, implementations of financial transactions will be explained in greater detail.

Referring to FIG. 3, a system is shown in which a user makes a payment to the virtual home (VH) of a recipient using an electronic bankers draft. The steps involved (the following step numbers refer only to FIG. 3 and are not to be confused with reference numerals elsewhere) are

1 Payer requests bankers' draft from account-holding financial institution

2 Bankers' draft sent to Payer

3 Payer forwards bankers' draft to Recipient's VH

4 Recipient's pays bankers' draft into account at own bank

5 Inter-bank balances are settled, preferably by a small number of same day high value payments (this is an advantage in that the number of transactions through the banking system (and hence load on the banking system network) can be reduced).

Referring to FIG. 4, a system is shown in which a user makes a payment to a recipient using the user's virtual home (VH). The steps involved (the following numbers refer only to FIG. 4 and are not to be confused with reference numerals elsewhere) are:

1 Payment is initiated or authorised in an appropriate fashion. Three examples of payment initiation/authorisation methods are

A: Merchant sends e-bill to VH, which is subsequently authorised by individual (e.g. utility payment)

B: Individual authorises payment at point-of-sale by presentation of VH smart card ID, and PIN number. Pre-authorised bill subsequently sent by merchant to VH

C: Individual makes spontaneous payment, say to a charity or a child, and writes ‘cheque’ within VH

2 The individual's virtual home (VH) contains details of all stored-value and credit accounts, and instructions as to their use and directs information accordingly

3 VH requests bankers' draft from one of several account-holding financial institutions

4 A bankers' draft is sent to the recipient

5 Recipient sorts drafts and presents to originators, either in bulk directly or via- intermediary

6 Inter-bank balances are settled, preferably by a small number of same day high value payments (as above this may reduce the number of banking transactions)

7 Recipient's bank provides reconciliation information by periodic bank statement

### Postal Delivery

As mentioned above, a request to deliver an object may be sent electronically. An example of delivery preference information for parcels is shown below in table 2. This may be termed recipient determination of delivery address.

| Condition | Action |
|---|---|
| If parcel is LARGE | only deliver to HOME |
| 9 am-6 pm weekdays | deliver to WORK address xxxx |
| weekends | deliver to HOME, but only after 10 am |
| if parcel is URGENT | notify by TELEPHONE number yyyy |
| *ALL | do not deliver between zz/zz/zzzz and aa/aa/aaaa |

This includes both general preferences and a temporary condition marked with an asterisk, for example when a user is on vacation (which may be coupled to an instruction to notify a user of requested delivery). Whilst the above example is applied to parcels, conditions may be applied to other objects, and various categories may be defined, for example LETTER, RECORDED DELIVERY, VALUABLE, PERISHABLE. Also, specific senders may be identified—for example a regular food delivery may be left with neighbours or outside if the user is not available.

Anonymous Receipt of Information

In a manner related to the redirection of post, an embodiment of the invention may enable a user to request information without being permanently entered on a mailing list. This facility may be termed time-limited anonymous disclosure of desire to purchase. This can best be explained by means of an example such as the case where an individual wishes to buy, for example, a sofa. The user, at an appropriate retail or information point which may be a shop or may be a website indicates a desire to purchase a sofa. The user may provide information identifying either one or more preferred manufacturers/suppliers and/or one or more “blacklisted” manufacturers/suppliers or indicates that all available manufacturers/suppliers are to be included, other relevant product information (for example colour, size etc). In the case of an electronic transaction, the user may have had the opportunity to preview some details of products available and select from lists in any known manner of selecting from products on offer.

In addition to information specifying the product and supplier, the user may indicate a period of time for which he wishes to receive marketing material, which may have a default value if not specified, for example 1 month. The user may further specify permitted-.methods of contact, for example telephone, e-mail or conventional mail. In response to this, the server (which may advantageously, but not necessarily, be a secure server as described above-holding other information concerning the user) is arranged to send to each selected supplier/manufacturer a time-limited address alias, any information provided by the user specifying the product requested and optionally other anonymous information concerning the user, if available, such as wide-area postcode, approximate age, gender, income band, preferences.

The validity period is preferably communicated to the supplier and the supplier, knowing that mailing after expiry of the period will be futile, can configure mailing systems to avoid wasting resources on further mailing to the user; the supplier can send fewer mailings, to users who are genuinely interested. However, if the supplier does not do this, the user will in any event be protected from further “junk mail”.

In the case of contact by E-mail, this can be re-directed in a known manner to the user's chosen E-mail address, until the time period expires, and thereafter returned or deleted if sent.

In the case of contact by physical mail, which may be useful for delivery of product brochures or samples, there are several options. If the supplier uses a delivery agent who participates in recipient determination of delivery address as explained above, the delivery agent will be supplied with an appropriate address corresponding to the address alias during the period when the user wishes to receive information and thereafter will be told to return all items to the sender. If not, the address alias can include both a conventional physical address of a forwarding agent and a user identifier (for example user 123456 c/o mail forwarding agent, address, postcode); items delivered conventionally to the forwarding agent can then be forwarded to the appropriate user while the alias remains valid or returned to the sender if not.

In the case of contact by telephone a telephone alias number can be supplied which is redirected to a number specified by the user for the period of time and thereafter disconnected.

To summarise the advantages of this method, for a user it provides a quick and easy method to obtain brochures from multiple suppliers without risk of abuse of address data, to a supplier it provides a new source of sales leads, which are high quality and low cost and to a delivery agent (such as The Post Office) it may result in more solicited and fewer unsolicited mailings, reduce abortive delivery or re-direction (if mail is sent after the expiry period, which should happen infrequently as the supplier will be aware that mail sent after the expiry period will not be delivered, mail can be returned at the first point in the delivery chain). This may lead to an improved perception of mailing services.

A further possibility made available by means of the verified electronic identity provided by the invention is participation in electronic voting or referenda. In a preferred implementation, a voting request (or other request to express a preference or opinion) is sent to and received at the secure server and an indication of voting or preference is sent back to the requester. By making use of the verified identity, the polling body can be sure that the respondent is the intended respondent. This feature may be provided independently in a further aspect in which the invention provides receiving at a secure server a request to vote or express a preference directed to a user whose identity has been verified and for whom verified information is stored on the secure server, preferably in accordance with one or more previously described aspects, receiving a vote or expression of preference from the user, preferably following validation of at least one key provided by the user, and transmitting an indication of the user's vote or preference from the secure server.

An important principle associated with the provision of a verified identity is that information is stored on a server and a user controls the granting of read access to at least a portion of the information but the control of write access to at least a portion of the information is held by an identity verifying authority.

As explained above, each of the features described herein is not, unless stated, limited to the specific example in the context of which it is described, but may be provided independently. Examples and preferred implementations are provided by way of explanation and are not intended to limit the scope of the invention. Methods and principles embodied in the context of specific technical implementations may be applied to other contexts and implementations. The text of the appended abstract is repeated below as part of this specification.

Information processing methods, systems and ancillary apparatus are disclosed which are generally concerned with the principle of making use of verified information concerning a user whose identity has been verified and stored on a secure server. The server effectively provides a point of presence which third parties may make use of to send or receive information to or from or concerning a specific user reliably, whilst enabling the user to retain control over the information, typically by means of a key such as a smartcard. This may facilitate a variety of transactions over a network, such as the Internet, which would otherwise require separate verification processes to provide the same level of reliability and thereby lead to a surprising improvement in efficiency of the network.

Where more than one party has a point of presence as mentioned above or “virtual home” transactions between parties may be simplified, in particular transactions which may be regulated or overseen by other parties.

In a further aspect, the invention provides a method of recording a transaction concerning first and second users, the first user having a first key to a first point of presence on a secure server providing first user data concerning the first user, the second user having a second key to a second point of presence on a secure server providing second user data concerning the second user, the method comprising:

receiving the first and second keys;

storing a record associated with the first user data containing first information concerning the transaction and identifying the second user;

storing a record associated with the second user data containing second information concerning the transaction and identifying the first user with the second user data.

The point of presence may be provided in accordance with any of the aspects or preferred features disclosed herein. The first and second information may be made available to a further user, for example an authority wishing to oversee the transaction. A check may be made (optionally subsequently) that the first and second information correspond. The transaction may involve a payment or transfer of an object from one user to another. The first and second information may be made available for viewing but not modifying by the respective users. One or both users may be notified that the information has been recorded. One of the users may receive the key of the other user to effect the transaction in which case the receiving user's key may be pre-stored and need not be received as part of the recordal of an individual transaction.

The information concerning the transaction may comprise symmetrical information.

There are several practical applications of this balanced or two party virtual home system. A first example includes payment to contractors where a tax authority such as the Inland Revenue (in the UK) wish to ensure that payments received and payments given correspond. Another example is in supplying prescriptions. For example, a user having a prescription may take this (or send it electronically) to a pharmacist. When the pharmacist supplies the prescription, an entry is made in both the pharmacist's and user's associated data concerning the prescription. In this way the prescriptions dispensed can be correlated with individual patients.

A first practical example, concerning payments to a contractor, will now be discussed.

### 1. APPLICATION OF VIRTUAL HOME TO THE INLAND REVENUE CIS SCHEME

In the following sections we first give our understanding of the existing CIS arrangements, then go on to discuss how CIS might operate if the Virtual Home concepts were to be adopted, and finally describe possible strategies for minimising impersonation and consequent tax evasion.

### 1.1 Simplified Overview of Existing CIS Arrangements

Subcontractors enrol with the Inland Revenue (IR) and receive either: (i) a photo-registration card (CIS4) if self-employed; (ii) a photo-bearing subcontractor's tax certificate (CIS6) if both turnover is in excess of £30k p.a. per partner/director and also various other tests are passed; or (iii) a construction tax certificate (CIS5) if a sub-contracting company that is too large or complex to use a CIS6.

Contractors are required to inspect the CIS4/5/6 of their sub-contractors periodically, and are forbidden by law from making payments to any sub-contractor who does not-have a valid CIS4/5/6.

Payments from a contractor to a holder of a CIS4 are made net of tax, and are recorded by the contractor monthly on a triplicate IR voucher CIS25. One copy is given to the sub-contractor, the contractor retains a second, and the third is sent to IR.

Payments from a contractor to a holder of a CIS6 are made gross of tax, and are recorded monthly by the sub-contractor on a further triplicate IR voucher CIS24. The sub-contractor passes all three copies to the contractor who adds his tax reference, returns one copy to the sub-contractor, keeps one copy, and forwards the third to IR.

Payments from a contractor to a holder of a CIS5 are also made gross of tax, and are recorded on a third IR voucher (CIS23), in this case a duplicate. The contractor retains one copy of the voucher, and the second is forwarded to IR. There is no copy for the sub-contractor.

All employing contractors are required to make end-of-year returns to the Inland Revenue using form CIS36.

### 1.2 Operation of CIS using Virtual Home concents

Sub-contractors, and their employing contractors, all enrol with IR and receive a smart card and associated Point of Network Presence (PNP) in return. Where a firm has several directors, each will be able to use his smart card to access all or part of the firm's PNP.

At the beginning of each new contract, the sub-contractor ‘registers’ with the employing contractor by either: (i) presenting his smart-card to the contractor in person and, in response to a system prompt, unlocking the smart card by entering a PIN number; or (ii) using his smart card and PIN number to access his firm's PNP from where he sends a secure e-mail to the contractor's PNP. Regardless of the method used, the act of registering gives the contractor ‘write-access’ to a ‘payment-received’ record page in the sub-contractor's PNP. The duration and validity of such ‘write-access’ can be varied; IR might require for example that sub-contractors re-register annually, or that a particular class of sub-contractor be registered with not more than one employing contractor at any one time.

Whenever the contractor pays the sub-contractor, he records the fact by making an entry on the sub-contractor's PNP ‘payments-received’ record page, and—in so doing—causes the system to make an equal and opposite entry on a ‘payments-made’ page within his own PNP The system will not permit entry of a payment if a sub-contractor's IR enrolment has expired. Periodically, both the sub-contractor and the contractor will make tax-returns to IR, using figures from their PNP, ‘payments-received’ and ‘payments-made’ pages respectively. Should IR wish to check these figures, it can do so be either requesting PNP read-access from the party submitting the tax-return, or—provided that data protection rules permit—take advantage of a permanent global read-access granted by the PNP-host.

Note that the scheme does not assume high levels of computer literacy among small sub-contractors and self-employed tradesmen. Such people will be able to grant the necessary permission to employing contractors by ‘passively’ presenting their smart card, and to the Inland Revenue by quoting the card address. A second example, concerning dispensing of prescriptions, will now be discussed.

### 2. APPLICATION OF VIRTUAL HOME TO HEALTH SERVICE PRESCRIPTIONS

In the following sections we first give our understanding of the existing arrangements for the issue, fulfilment and subsequent processing of medical prescriptions. We then go on to discuss how these existing arrangements might be improved were the Virtual Home concepts to be introduced.

### 2.1 Simplified Overview of Existing Prescription Arrangements

Medical prescriptions are issued by GPs and other NHS prescribers, and are then fulfilled by community pharmacists, by dispensing GPs, and by appliance contractors under licence to local Health Authorities. Collectively these three are known as dispensing contractors.

No later than the fifth day of the month following that in which the medicine was dispensed, dispensing contractors are required to despatch their prescriptions to the Prescription Pricing Authority (PPA). The PPA also receives what are called ‘Personal Administration’ claims directly from GPs in respect of medicines—such as influenza vaccine—administered by a GP to a patient. Upon arrival at the PPA, prescription forms are passed through high speed numbering machines. The forms are then transferred to data input processing teams who, after deciphering and interpreting the orders and taking account of endorsements made to the form by the dispenser, enter the data into a computer system. The PPA calculates the amount due for prescriptions to the dispensing contractors and—in the case of pharmacy and appliance contractors—makes the payment directly.

Focusing now on pharmacists, they are entitled to reimbursement and remuneration for the following: (i) the total price of the medicines, appliances and chemical reagents supplied, less a deduction for the discount received by the contractors; (ii) other fees and remuneration as listed in the Drug Tariff; (iii) a professional fee for each item dispensed; and (iv) an allowance for containers and measuring devices. Prescription charges collected from patients by the pharmacy contractor are deducted from the payment made by the PPA. In the year to 31 Mar. 1999, the PPA—which serves England only—processed some 531 million prescriptions, using the services of about 2000 staff and incurring operating costs of £47 million. Pro-rating these figures by population, the total number of prescriptions UK-wide in the same year was some 635 million at a cost of about £56 million.

### 2.2 Prescription Arrangements Using the Virtual Home Concept

In the following discussion, which looks at how Virtual Home could be used to modernise the current paper-based prescription system, we take four perspectives: those of a patient, a GP, a pharmacist, and of the Prescription Pricing Authority.

2.2.1 A Patient's Experience

Consider, if you will, the lot of Beth Briggs, a 55 year-old lady who suffers from diabetes. It is November 2002, and she is peeling potatoes for her family's supper. The knife slips, Beth cuts her thumb, shrugs and thinks nothing of it. But over the next few days the cut turns septic, and so Beth eventually makes an- appointment to see her GP. On arrival at the surgery, Beth give the receptionist her new VH smart card—which she had received a week or so earlier. The receptionist inserts the card in a reader and prompts Beth to enter a PIN number on a keypad. Within a couple of seconds, the receptionist is presented on a screen with the ‘health’ page of Beth's VH. And, with Beth's agreement, she notifies the VH host of the fact that Beth is registered with that particular practice by entering the practice's VH address in the appropriate field.

After a brief wait Beth sees her GP who decides that she needs a short course of anti-biotics to treat the septic cut. As her registered GP, the doctor automatically has write access to the health pages in Beth's VH, and thus writes the prescription for the anti-biotics to her prescription page The act of so writing causes the VH host to make an equal and opposite entry on the ‘prescriptions-issued’ page within the GP's VH.

Anxious to make the most of her appointment, Beth also asks the GP for her annual anti-flu jab. He agrees, administers it there and then, and records the fact on the ‘treatment received’ page within Beth's VH. As before, the VH host makes an equal and opposite entry in the GP's VH, this time on the ‘medicines dispensed’ page.

Finally the GP enquires after Beth's general health, and in particular, her ongoing treatment for diabetes. She reports no problems, and asks him for a repeat prescription for insulin. Rather than using paper in the traditional way, he writes a multiple prescription—for 6 monthly instalments of insulin, each with a due date—to the appropriate page within Beth's VH.

On her way home, Beth stops off at the local community pharmacy, hands over her smart card, enters her PIN number, and requests the anti-biotics and one instalment of insulin. The pharmacist complies, and records the transaction by entering his VH address against the appropriate entries on Beth's VH prescription page. As he does so, the VH host makes an equal and opposite entry on the pharmacist's ‘medicines dispensed’ page.

A few days later, Beth decides to arrange for her monthly supplies of insulin to be delivered by post. With the help of her daughter, she inserts her smart card in the spare slot of their interactive digital television, or in the card reader attached to the family PC, enters a PIN number in response to a prompt, and so gains entry into her own VH. Following the link to health and then to prescriptions, she selects the 5 remaining insulin instalments and instructs the VH host to arrange for supply by a mail-order pharmacist, probably selected from a list within VH. On the due date for each insulin instalment, VH host sends a one-time read-access by secure e-mail to the selected pharmacist who responds by mailing the insulin and entering his VH address on Beth's prescription page as confirmation. Should Beth go away on holiday and lose her stock of insulin, she would be able to obtain a replacement from any local pharmacist by over-riding the standing mail-order instruction within her VH.

Because her diabetes is a chronic condition, Beth has probably obtained an FP92 Exemption certificate, and thus receives free prescriptions. She is in good company. Any one under 16, any one over 60, any pregnant woman or mother with babe-in-arms, and any one receiving one of the various low-income benefits, also qualifies for free prescriptions and must obtain documentary proof of status-from one or other government agency. Of the few people who are not eligible for free prescriptions, some choose to buy an annual ‘season-ticket’ from their LHA. All of these-different documents can be regarded as facets of identity, and in time the government agencies may choose to record them using VH. As this occurs, individuals will be able to use permissioning to show particular facets to pharmacists, and thus avoid the need for the current paper chase.

2.2.2 As Seen by a GP, a Pharmacist and the PPA.

Many GP's and pharmacists use IT systems, the former for storing and retrieving patient records, the latter to keep records of stocks on-hand and prescriptions dispensed. Assuming that VH is introduced, such systems will be modified by their suppliers to interface with the VH system and so avoid the need for double data entry.

At the end of each month, each GP practice and pharmacy will give the PPA permission to read relevant pages within their VHs. In case of GPs, the PPA will use information from the ‘prescriptions-issued’ page for statistical purposes, and information from the ‘medicines dispensed’ pages to calculate monies owed to the practice for directly administered medicines. Similarly the PPA will use information from a pharmacy's ‘prescriptions dispensed’ page to calculate monies owed. For both pharmacies and GPS, the PPA will be able to read account details for payment purposes from a further VH page, and will be able to send notification of monies to be paid by secure e-mail to the relevant VH.

Note that adoption of the VH system should reduce opportunities for avoidance of prescription charges. At present, when a medicine is available ‘over-the-counter’ at a retail price less than the prescription charge, the pharmacist often makes a direct retail sale rather than dispensing against the prescription. In consequence the PPA loses revenue. Using VH it should be possible to record the number of occasions on which a pharmacist looks at a prescription without dispensing against it, and thus control this form of tax avoidance.

Note further that the VH system can potentially be used to influence the prescribing habits of GPs. Periodically, say once a month, the PPA writes a list of recommended medicines to an appropriate page within the GP's point-of-presence and—when prescribing—the GP would normally select items from this list.

Finally adoption of VH should enable the PPA to eliminate the use of paper entirely. Cost savings should be considerable. And provided that due care is taken about data protection, it should also be possible to gather anonymous statistical information—from patients, GPs and pharmacists—of a richness never yet achieved.

1. A method of providing a point of presence on a network for a user whose identity has been verified, the point of presence providing a source of verified information corresponding to the user or a destination for received information directed to the user, the method comprising:
storing on a secure server verified information corresponding to the user based on a verified identity of the user;
providing to the user one or more keys enabling access to the information, the server being configured to permit the user, on validation of at least one key, to release verified information from the secure server or to access received information but not to modify the verified information.

2. A method according to claim 1 wherein further information is stored, the server being configured to permit the user, on validation of at least one key, to modify the further information.

3. A method according to claim 1 or 2, further comprising:
receiving a request from a user to provide at least a portion of the verified information to a specified recipient over the network; and
providing information to the specified recipient over the network following verification of at least one key provided by the user.

4. A method of supplying verified information concerning a user over a network to a recipient, the method comprising:
storing on a secure server verified information corresponding to the user whose identity has been verified and based on the verified identity;
receiving at the secure server a request from the user to provide at least a portion of the information to a recipient over the network;
verifying at least one key provided by the user to validate the request;
in response to successful validation providing verified information to the recipient from the secure server over the network.

5. A method according to any preceding claim, wherein the or each key comprises information stored on a key carrier.

6. A method according to claim 5, wherein the step of verifying at least one key includes reading information from the key carrier.

7. A method according to claim 5 or 6, wherein the key carrier is a smartcard.

8. A method according to claim 7, wherein the smartcard is a multi-application smartcard including means for storing at least one key affording access to the verified identity and means for storing at least one application.

9. A method according to any of claims 5 to 8, wherein access to the key carrier is further protected by means of a secondary security feature.

10. A method according to claim 9 as dependent on claim 7 or 8; wherein logic embedded in the smartcard is arranged to require the secondary security feature to gain access to the key.

11. A method according to claim 9 or 10, wherein a distinctive biological characteristic of the user is measured as part of the process of identifying the user, the method including storing information enabling validation of the characteristic as the secondary security feature.

12. A method according to any preceding claim wherein verifying the user's identity comprises checking a document which has been issued after a verification process.

13. A method according to any preceding claim wherein at least a portion of the verified information stored on the secure server is cross-checked with independent records for the user.

14. A method according to any preceding claim wherein the information stored on the secure server comprises a plurality of categories of information, the authorisation required to read or modify the information varying between the categories.

15. A method of supplying verified information concerning a user over a network to an authorised recipient, the method comprising:
storing on a secure server verified information corresponding to the user whose identity has been verified and based on the verified identity;
receiving at the secure server a request from the recipient to provide at least a portion of the information over the network;
verifying at least one key provided by the recipient to validate the request;
in response to successful validation providing information to the recipient from the secure server over the network.

16. A method of transmitting data concerning a user to a recipient, the method comprising transmitting the data concerning the user to the recipient over a network from a secure server and further comprising transmitting an identifier indicating that at least a portion of the data transmitted comprises verified information stored on the secure server following verification of the identity of the user.

17. A method of obtaining over a network verified information concerning a user whose identity has been verified, comprising:
requesting information from a user;
establishing communication over a network with a secure server on which is stored verified information concerning the user based on a verified identity of the user;
following provision of at least one key by the user and validation by the secure server of the or each key supplied, receiving verified information from the secure server over the network.

18. A method according to any preceding claim, further comprising receiving a communication directed to the user and processing the communication in accordance with at least one predetermined condition.

19. A method according to claim 18, wherein the communication comprises one of:
a debit or credit transaction request;
a document to be notified to the user;
a request from a source to deliver a physical item to the user.

20. A method of processing a debit or credit transaction request comprising, at a secure server on which is stored a database of information corresponding to a plurality of users the identity of whom has been verified, the steps of:
receiving the transaction request, the request including an identifier of a target user with whom a transaction is requested and an identifier of the requester;
searching the database for information identifying at least one banking server capable of processing the transaction request for the target user and, if successful,
forwarding the transaction request from the secure server to a banking server with authorisation to complete the requested transaction in accordance with at least one predetermined condition, or returning an identifier of a banking server and account to the requester.

21. A method according to claim 20, further comprising acknowledging the request or signalling if the user is not identified or banking information is not provided for the user.

22. A method according to claim 20 or 21, wherein the at least one predetermined condition includes an instruction to hold at least one specified transaction request or category of request pending authorisation by a user.

23. A method according to claim 20, 21 or 22, wherein the at least one predetermined condition includes an instruction to forward at least one specified transaction request or category of request to a default account after a predetermined time in the absence of authorisation.

24. A method according to any of claims 20 to 23 wherein the secure server serves as a banking server.

25. A method of receiving a document destined for a user for which acknowledgment of receipt is required, the method comprising, at a secure server on which is stored a database of information corresponding to a plurality of users the identity of whom has been verified, the steps of:
receiving from a source a document and an identifier of a target user;
searching for notification information for the target user in the database, and, if successful,
notifying the user of receipt of the document based on information stored in the database;
following successful notification, signalling to the source that the document has been notified to the target user.

26. A method of controlling delivery of a physical item to a user, the method comprising, at a secure server storing a database of information corresponding to a plurality of users the identity of whom has been verified, the steps of:
receiving over a network a request from a source to deliver a physical item to a target user;
searching for delivery preference information for the target user in the database and, if successful,
communicating to the source delivery preference information for the target user.

27. A method according to any preceding claim wherein the network is a publicly accessible distributed network, preferably the Internet.

28. A secure server configured to provide a point of presence on a network for a user whose identity has been verified, the point of presence providing a source of verified information corresponding to the user or a destination for received information directed to the user, the server comprising:
means configured to receive an input signalling that the identity of the user has been verified;
means configured to store verified information corresponding to the user based on the verified identity;
means configured to connect to the network to supply verified information corresponding to the user or to receive information directed to the user;
means configured to validate at least one key supplied by user;
means operative in response to successful validation to permit the user to release verified information from the secure server over the network or to access received information directed to the user, wherein the server is configured not to permit the user to modify the verified information.

29. A network terminal device comprising:
means configured to read a key carrier containing a key affording access to verified information concerning a user whose identity has been verified stored on a secure server;
means configured to connect over a network to the secure server to validate the key;
means configured to receive input from a user; and
means configured to forward a command over the network to the secure server to authorise supply of the verified information to a recipient in response to the user input or to provide access by a user to information directed to the user received at the secure server.

30. A device according to claim 29, wherein the device comprises an Internet kiosk having an integrated smartcard reader and configured to connect to the secure server.

31. A data packet comprising information concerning a user and an identifier indicating that the information has been stored on and transmitted from a secure server following verification of the identity of the user.

32. A multi-application smartcard comprising means for storing a plurality of applications on the smartcard and means for communicating common information concerning the identity of a user between the applications based on information which has been verified and stored on a secure server.

33. A method of managing applications on a multi-application smartcard comprising displaying a list of applications on the smartcard and in response to a request from a user, which request is validated by key or secondary security feature, modifying the applications stored on the smartcard.

34. A method according to claim 33, wherein modifying includes downloading a further application or deleting an application.

35. A mobile communications device comprising:
means configured to connect over a network to a secure server on which is stored verified information concerning a user whose identity has been verified;
means configured to validate a key with the secure server; and
means configured to send a command to the secure server to release at least a portion of.the verified information over the network or to access information directed to the user.

36. A smartcard configured as a payment card comprising means storing information arranged to direct a payment request to a secure server arranged to perform a method according to claim 20.

37. A computer program or computer program product carrying computer readable instructions for carrying out a method according to any of claims 1 to 27 or 33 or 34 or 42 to 50.

38. A data packet for transmission over a network carrying computer readable instructions for carrying out a method according to any of claims 1 to 27 or 33 or 34 or 42 to 50.

39. A secure server configured to perform a method according to any of claims 1 to 27 or 33 or 34 or 42 to 50.

40. A user terminal configured to communicate with a secure server according to claim 39.

41. Use of verified information, based on a verified identity of a user and stored on a secure server, in a transaction over a network.

42. A method of directing information or an object from at least one source to a user, the method comprising:
providing information identifying an object or information of interest to the user to at least one source;
providing a severable communication pathway from the at least one source to the user;
after a period of time, severing the communication pathway.

43. A method according to claim 42 including setting the period of time based on user input.

44. A method according to claim 42 or 43 wherein providing the communication pathway comprises providing an address alias.

45. A method according to claim 44 further comprising providing information to a delivery agent enabling the address alias to be translated.

46. A method according to claim 44 further comprising translating an address alias on request from a delivery agent.

47. A method according to any of claims 42 to 46 including receiving information or an object from at least source directed to the user and forwarding the information or object to the user.

48. A method according to claim 44 wherein severing the communication pathway comprises changing the address pointed to by the address alias.

49. A method according to any of claims 42 to 48 wherein information identifying-characteristics or preferences of the user, but not uniquely identifying the user, is communicated to the at least one source.

50. A method according to any of claims 42 to 49 wherein information concerning the user is stored on a secure server in accordance with or arranged to operate a method according to any of claims 1 to 27.

51. A method of processing a financial transaction via a computer network having verified information concerning at least one of a donor and recipient of funds stored on a secure server, the method comprising:
forwarding a request for funds to a banking server associated with the donor configured to output a data packet comprising an electronic bankers' draft;
forwarding the data packet to the recipient;
forwarding the data packet from the recipient to a banking server associated with the recipient;
transferring funds between the banking server associated with the donor and the banking server associated with the recipient to complete the transaction.

52. A method according to claim 51 wherein funds corresponding to a plurality of transactions are consolidated prior to transfering funds between the banking servers.

53. A method according to claim 51 or 52, wherein verified information concerning the recipient is stored on the secure server and wherein the data packet is forwarded to the secure server.

54. A method according to any of claims 51 to 53, wherein verified information concerning the donor is stored on the secure server and wherein the request for funds is forwarded from the secure server.

55. A data packet transmitted over a network comprising an electronic bankers' draft originating from a banking server and containing information to credit an amount of funds pre-allocated by the banking server, the packet being authenticated by the banking server.

56. A method of processing data comprising:
at least partially processing a payment transaction or request at a secure server at which verified information concerning a user is stored, at least part of which verified information is under the control of the user, and
modifying a credit history record associated with the user based on the payment transaction or request.

57. A method of recording a transaction concerning first and second users, the first user having a first key to a first point of presence on a secure server providing first user data concerning the first user, the second user having a second key to a second point of presence on a secure server providing second user data concerning the second user, the method comprising:
receiving the first and second keys;
storing a record associated with the first user data containing first information concerning the transaction and identifying the second user;
storing a record associated with the second user data containing second information concerning the transaction and identifying the first user with the second user data.

58. A method according to any of claims 1 to 27 or 51 to 56 further comprising processing a transaction concerning said user and a further user, the further user having further verified information concerning the further user stored on a secure server, the method comprising recording the identity of the further user and information concerning the transaction in a record associated with the verified information concerning the first user and recording the identity of the user and information concerning the transaction in a further record associated with the further verified information concerning the further user.

59. A method according to claim 57 or 58 wherein complementary entries concerning the transaction are recorded for the users.

60. A method according to any of claims 57 to 59 further comprising making the records available to an overseeing authorised user.

61. A method according to any of claims 57 to 60 further comprising checking said records for mutual consistency.
